(19) United States
(12) Patent Application Publication
(10) Pub. No.: US 2024/0119348 A1
(43) Pub. Date: Apr. 11, 2024

(54) BOT TRANSPORT PROCESS ACROSS TENANTS

(71) Applicant: SAP SE, Walldorf (DE)

(72) Inventors: Himabindu Guttapalem, Walldorf (DE); Akshay Thakare, Walldorf (DE); Shashank M N, Walldorf (DE); Vijayashree Ingalahalli, Walldorf (DE); Riya Subhedar, Walldorf (DE)

(21) Appl. No.: 17/963,297

(22) Filed: Oct. 11, 2022

(51) Int. Cl. G06N 20/00; G06F 16/13

(52) U.S. Cl. CPC G06N 20/00; G06F 16/137

(57) ABSTRACT

Provided are systems and methods for transporting a bot from runtime of a first tenant into a runtime of a second tenant. The transport process can include transferring bot configurations, machine learning models, training data, and the like. In one example, a method may include exporting a file from a first tenant in a multi-tenant environment, wherein the file comprises a chatbot program, one or more machine learning models for generating a response from the chat bot program, and training data used to train the one or more machine learning models for generating the response, importing the file into a second tenant of the multi-tenant environment, and installing the bot program, the one or more machine learning models, and the training data within a directory of the second tenant of the multi-tenant environment.

### BACKGROUND

Tenancy in cloud computing refers to sharing computing resources in a private or public environment that is isolated from other users/tenants and kept secret. Examples of the types of tenancy include single-tenant and multi-tenant. A single-tenant cloud runs on a dedicated infrastructure in which the hardware, storage, and network are dedicated to a single client, and there are no neighbors to share hosted resources with. Meanwhile, in a multi-tenant cloud, multiple tenants can share in access to application instances, database storage, and the like. For enterprise customers having multi-tenancy landscapes, the tenants may be located on the same host/system sharing resources or the tenants may be located on different hosts/systems.

Recently, organizations (e.g., an enterprise customers, etc.) have begun using multiple tenants hosted by a cloud provider to provide multiple different landscapes for an organization. As a simple example, an organization may use a first tenant for a training environment for applications and models and use a second tenant for a productive environment (e.g., for live interaction with the applications and models by customers/clients, etc.) In this scenario, an organization will often have a need to transport a bot program such as a chatbot from one tenant to another (e.g., from a training environment to a productive environment, etc.) However, at present there is no easy way to do this because cloud providers do not offer a way to move a bot from one tenant to another. Instead, the organization usually must build and train the bot separately in each tenant.

### BRIEF DESCRIPTION OF THE DRAWINGS

Features and advantages of the example embodiments, and the manner in which the same are accomplished, will become more readily apparent with reference to the following detailed description while taken in conjunction with the accompanying drawings.

FIG. 1 is a diagram illustrating a multi-tenant computing environment for application development in accordance with an example embodiment.

FIGS. 2A-2C are diagrams illustrating a bot transport process across tenants in accordance with an example embodiment.

FIG. 3 is a diagram illustrating a process of transporting non-sensitive bot configurations across tenants in accordance with an example embodiment.

FIG. 4 is a diagram illustrating a process of importing a bot into multiple target tenants in accordance with an example embodiment.

FIG. 5 is a diagram illustrating a method of transporting a bot across tenants in accordance with an example embodiment.

FIG. 6 is a diagram illustrating a computing system for use with any of the examples herein in accordance with an example embodiment

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

Chatbots rely on machine learning models to perform functions (i.e., chat) in an autonomous manner. For example, a chatbot may execute one or more machine learning models on a natural language input to predict a response to an inquiry from a user. A chat application or chat function is often provided by a website, mobile application, or the like, which helps users to receive automated answers from a bot, rather than waiting to discuss the issues over the phone or look for the answers to questions in other places. The machine learning models often require a significant amount of training that can require months of time in order to fully develop a model that is accurate enough for use in a productive environment. In a traditional multi-tenant environment, a chatbot must be individually developed from scratch within each tenant due to the isolation amongst the different tenants created by a cloud provider. This requires the enterprise to retrain the same model. This often results in models that are not consistent across different tenants and redundantly consumes resources.

The example embodiments are directed to a host system (e.g., a software application, etc.) that can transport a bot such as a chatbot across different tenants. In addition to transporting the bot program, the host system can transport machine learning models, training data for the machine learning models, bot configurations (e.g., non-sensitive, etc.), external channel configurations, external communications/calls, and the like. The host system may export the bot program, the training data, the configurations, and the like, compress the exported programs and data, and store it in a zipped file or other compressed file. The host system may import the zipped file into a different tenant, unpack the zipped file, and install the contents within the different tenant including the bot program, the models, the configurations, the training data, and the like. The host may store the training data within directories/folders of the different tenant, and configure settings of the different tenant for the bot program. In addition, the host system may establish a network connection/channel with an external resource of the bot program/machine learning models such as a website, a database, and the like.

In the example embodiments, a tenant refers to a customer instance or group of user accounts who share access with specific privileges to software/data hosted by a service provider such as a cloud provider. An enterprise customer is a large business or company with multiple users. A landscape is an environment separation based on the usage of applications (e.g., development, testing, production, etc.) A data center is a location/region where the tenant infrastructure is located. A chatbot is a computer program designed to simulate conversation with human users. A version is an identifier or other indicator used to categorize unique states of a software application. Design time data refers to training data inside a chatbot which is version specific and used when the training model (machine learning model) is generated to train the model to determine intents, entities, skills, and other attributes, and also to generate a response to a user chat inquiry such as natural language response. The configurations refer to bot specific artifacts which are separate from design time data, and which are not version specific. Configurations can be customized in the tenant locally based on the bot usage in the tenant.

Recently, tenancy has been used as a method for isolating different execution environments of an enterprise. For example, a first tenant may be used for a training environment where applications and models can be trained, and a second tenant (or more) may be used for a live environment where the trained applications and models can operate in a live environment such as those associated with a website performing e-commerce and the like.

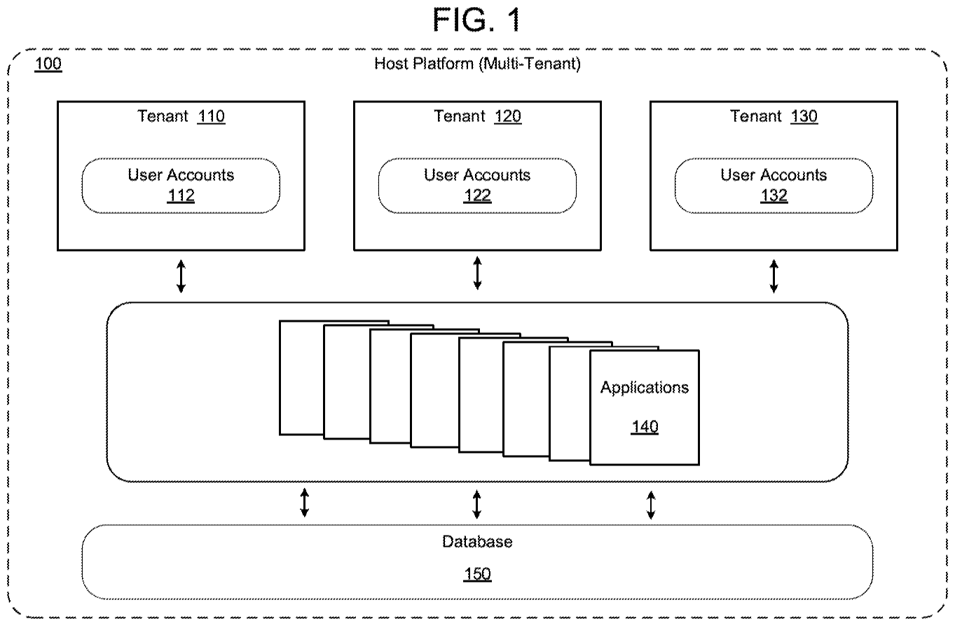

FIG. 1 illustrates a multi-tenant computing environment for application development in accordance with an example embodiment. In this example, the multiple tenants are sharing resources on the same host system. However, it should also be appreciated that the multiple tenants may be installed on different hosts/systems and may not share resources. Therefore, FIG. 1 is just an example and is not meant to limit the architecture of the multi-tenant environment. Referring to FIG. 1, a host platform 100 such as a cloud platform, a web server, a database, and/or the like, which implements a multi-tenant environment for a customer. Here, the customer is an enterprise customer with multiple tenants hosted by the host platform 100 including a tenant 110, a tenant 120, and a tenant 130. Each tenant 110, 120, and 130 may include its own different groups of user accounts 112, 122, and 132, respectively. Each of the tenants 110, 120, and/or 130 may require different access credentials. As noted, the tenants 110, 120, and 130 may be logically isolated by the host platform 100 (e.g., via a cloud provider, service provider, etc.) while at the same time being physically integrated together in the host platform 100. However, this is just one example and it should also be appreciated that the solution will work even if the tenants are hosted on different host systems.

In the example of FIG. 1, the tenants 110, 120, and 130 may share access to an application layer with multiple instances of software applications. The tenants 110, 120, and 130 may also share access to data within a database 150. For example, the host platform 100 may provide a respective dedicated instance of a shared software application 140 to each of the tenants 110, 120, and 130 including its own data, configuration, user management, functionality, and the like. Each of the tenants 110, 120, and 130 may have their own name spaces that isolate the respective tenants from each other. It should also be appreciated that the tenants 110, 120, and 130 may have access to different software applications, access to a different data, and the like, which is controlled and isolated by the host platform 100. For example, each tenant's data may remain invisible to the other tenants hosted on the host platform 100, even when the tenants are part of the same enterprise.

In some cases, bot programs may be installed within a tenant from among the tenants 110, 120, and 130, and the customer/enterprise may desire to transport the bot program to another one of the tenants. For example, the customer may desire to transport a bot program from the tenant 110 to the tenant 120. A bot program such as a chatbot may include a machine learning model for generating responses to queries (chat, questions, etc.) from users. The ML model may include a number of files with training data, intents, actions, scripts, and the like. Typically, a copy of the bot is constrained from being transferred across tenant landscapes because it is difficult to transfer the different intents, actions, scripts, etc. from one tenant to another and still have a successful execution. Therefore, the model is typically trained independently within each tenant where the bot will be live. The training ensures that the actions taken and the intent used for matching conversation state, etc., are matched with the tenant.

The example embodiments are directed to a bot transport process that enables a bot program (e.g., a chatbot, etc.) along with the local bot-specific configurations, machine learning models, training data, and the like, to be transported from a source tenant to a target tenant. During an export process, the host system may generate a compressed file (e.g., a zip file) with multiple files extracted from the source tenant. The export process may retrieve a machine learning model or models used by the chatbot along with the data used to train the machine learning model. The export process may retrieve both the models and the training data, and export those with the chatbot. In addition, the configurations of the bot that are specific to the bot including the bot address (e.g., URL, etc.), the authentication credentials (e.g., format, types, etc.), and the like. The configurations may only include non-sensitive data (e.g., format, placeholders, identifiers, etc.) of the data values that are needed for the respective configuration instead of the actual authentication credentials, URLs, etc.

The bot transport process provides a way to transport/copy the bots across tenants (i.e., from a source tenant to a target tenant, etc.) securely without the need to develop the bot from scratch in the target tenant. The transport process also offers the flexibility for the customer to handle the design time data (training data), configurations (e.g., sensitive data, non-sensitive data, etc.) separately during transport. With this feature, customer can transport the bot artifacts (design time data, non-sensitive configurations) across tenants and start using the bot in target after customizing the sensitive configurations (e.g., URLs, credentials, etc.) in the target tenant. The host system may export the design time data, non-sensitive bot configurations from source tenant and the possibility to download the exported content into a .zip file.

In some embodiments, the .zip file may be signed with a hash key by the host platform (e.g., host application, etc.) within the source tenant to enable file integrity checks as part of using the exported file in further steps such as to import the .zip file into a target tenant and unpack the files within the target tenant thus securely moving the files from one tenant to another tenant within the multi-tenant environment. The import process may then validate the .zip file by performing security and integrity checks. After successful validation, the host platform may import the data from exported .zip file into the target tenant which creates/updates the bot in the target tenant. With this feature, customers can also automate the bot delivery process to release the bots to target tenants and scale-up by simultaneously importing the bot into multiple target tenants.

Some of the benefits of the example embodiments include the ability to transport bots across tenants, data centers, landscapes, and the like. The host system may separate bot artifacts for design time and bot configurations to offer a controlled way of transport based on the requirement scope from end customers where the customers can choose whether they want to transport only design time/training data. Furthermore, the process provides a separation between bot development and bot release and deployment. For example, the bot can be developed in a first tenant that is designated for development and transported to a second tenant that is designated for testing. Once tested, the bot may be transported to a third tenant designated for providing a live productive environment. Here, the bot development/changes to the training data that occur during the developing in the development tenant can be exported and imported into the subsequent tenants designated for testing and production. In addition, the transport process includes additional layers of security through a hashing process and integrity check. Furthermore, when importing the bot into the target location, the bot can be customized without changing the design time data. Furthermore, the training model is included in transport data which ensures same behavior/functionality of the bot after import to the target tenant.

The training data is not tied to any particular environment. End users can store the training data as files (e.g., CSV files, XML files, etc.) on their end during development and then import them into the target system, but this is hard to maintain and does not guarantee that the machine learning model will be trained with consistency across tenants/landscapes (e.g., between dev and prod environments, etc.) since the model will be retrained when new training data is imported into target tenant without this solution. Additionally, the example embodiments also transport attributes like actions to be taken when an intent is matched, conversation state flows between intents and other information which cannot be imported via CSV files, etc.

During live execution/runtime of the bot, the training data is not required for the machine learning model of the bot to respond to chat input but it is required to determine the next steps to be taken once the user intent has been identified by the machine learning model. For example, the machine learning model may determine that an input sentence refers to a purchase order, then a machine learning model may use the training data to decide how to fulfil the users request such as whether more information about the purchase is needed or if the software can call a webhook/remote call or something else to process the request.

The host platform 100 shown in FIG. 1 may include a host application such as a software application that performs the bot transport process described herein. One such example of a software application is a chatbot development software application that comprises a collection of natural language processing (NLP) services and enables users/developers to build, train, and monitor chatbots. As an example, the software may provide users with controls for configuring the bot via a user interface. As another example, the software may provide an application programming interface (API) with controls for configuring the bot. The software application may be used to build and then train the chatbot, and connect the chatbot to external servers, websites, back-end systems, third-party data providers, and the like. The software application may also enable a developer to version the chatbot and easily deploy it to specific environments. For example, the developer may be able to create a new version of the bot and test it in a staging environment before moving it to the production environment. The software application may also set up shared accounts which may be referred to as organizations such that groups of people can collaborate on several bots at the same time. You can create private and public organizations. Grant permissions to members of the organization and teams.

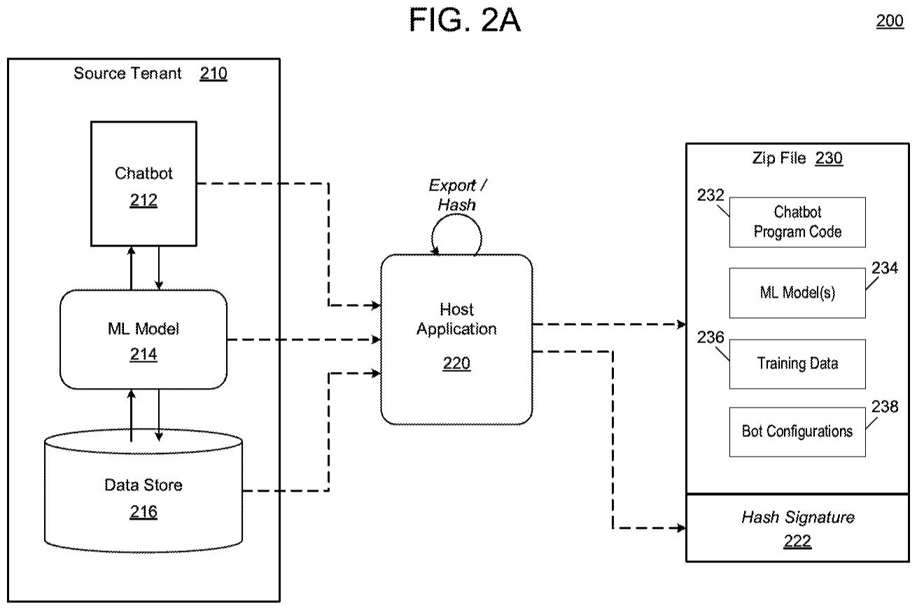

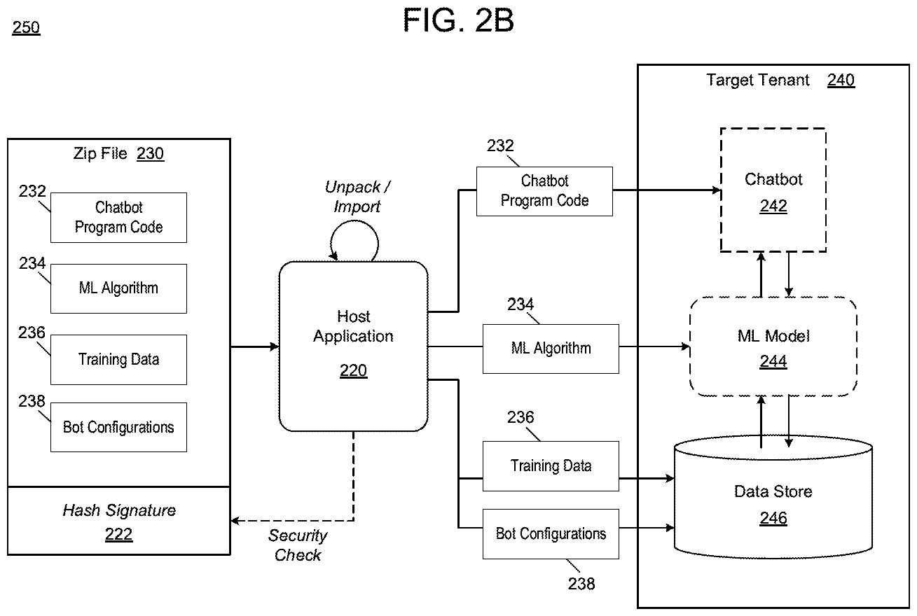

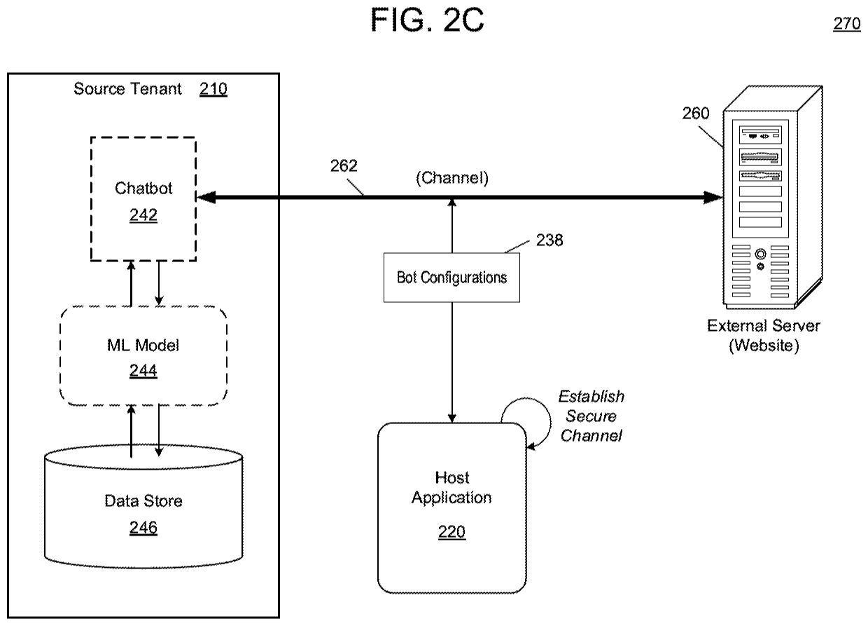

FIGS. 2A-2C illustrate a bot transport process across tenants in accordance with an example embodiment. In the examples herein, the bot transport process may be performed by a host system such as a host application 220 shown in FIG. 2A. As noted above, the host application 220 may be chatbot development application that enables bots to be developed within a training environment and transported to a productive environment. In this example, the host application 220 transports a chatbot 212 from a source tenant 210 shown in FIG. 2A into a target tenant 240 shown in FIG. 2B. The transport process includes both an export process and an import process.

FIG. 2A illustrates a process 200 of exporting the chatbot 212 from the source tenant 210 via the host application 220. Referring to FIG. 2A, the host application 220 may receive a request to transport a bot across tenants. For example, a user/developer of the chatbot 212 within the source tenant 210 may request transport of the bot to the target tenant 240 via a user interface (not shown). For example, the user may input a name or URL of the target tenant 240 into a field of the user interface and an identifier of the chatbot (e.g., an application identifier, model identifier, etc.) into a field of the user interface. In response, the host application 220 may extract files/folders of data from a data store 216 of the source tenant 210, compress them, and store them in a compressed file 230. Furthermore, the host application 220 may compress the machine learning model 214 (e.g., a machine learning algorithm, algorithms, program code, etc.) along with the training data into the compressed file 230.

In particular, the host application 220 may export chatbot program code 232, one or more machine learning models 234 (e.g., the algorithm of the model, the model itself, etc.), training data 236 which is used to train the one or more machine learning model, identifiers of the machine learning models, bot configuration 238 which may be customized by a developer within the source tenant 210, and the like. The exported files and data may be stored within the compressed file 230 and pulled out of the source tenant 210 and stored in a temporary storage (not shown) such as a temporary memory location, storage, or the like.

Furthermore, the host application 220 may store a hash function or the like, which can be used to generate a hash of the contents of the compressed file 230. For example, the hash function may be a cryptographic hash function such as MD5, SHA, etc. The host application 220 may input the compressed file 230 (or any files therein) into the hash function to generate a hash signature 222. The hash signature may include a digest of a predetermines size (e.g., 128 bits, 256 bits, etc.) regardless of the size of the input file.

FIG. 2B illustrates a process 250 of exporting the chatbot from the source tenant 210 into a target tenant 240, according to example embodiments. Referring to FIG. 2B, the host application 220 may import the compressed file 230 into the target tenant 240 in response to verifying the hash signature 222. For example, the host application 220 may run the compressed file 230 via the same hash function after import to recreate a hash signature and compare the recreated hash signature to the hash signature 222 stored in the compressed file 230. If the two hash signatures (values) match, the verification is considered a successful verification by the host application 220.

During the import, the host application 220 may unpack the contents/files within the compressed file 230 and install the unpacked contents/files within corresponding locations of the target tenant 240. For example, the host application 220 may install a new instance of a chatbot 242 within the target tenant 240 based on the chatbot program code 232 unpacked from the compressed file 230. In addition, the host application 220 may install a new instance of a machine learning model 244 within the target tenant 240. Likewise, the host application 220 may install the training data 236 and the bot configurations 238 within a data store 246 of the target tenant 240. The host application 220 may create new folders and/or directories within a domain of the target tenant 240 for storing the training data 236 and the bot configurations 238 and may also configure bot settings (e.g., authentication, URL locations, etc.) within the newly installed chatbot 242.

Furthermore, the host application 220 may connect the training data 236 to the newly-installed chatbot 242 thereby ensuring the chatbot 242 can access the training data 236. For example, the machine learning model 244 may be used to predict an intent of the natural language input received via a chat application by the chatbot 242. Next, the machine learning model 244 may use the training data 236 to decide how to fulfil the users request such as whether more information about the purchase is needed or if the software can call a webhook/remote call or something else to process the request.

FIG. 2C illustrates a process 270 of the host application 220 establishing a communication channel 262 between an external web server 260 and the chatbot 242 imported into the target tenant 240. In this example, the host application 220 may establish an authenticated communication channel 262 between the chatbot 242 and the external web server 260 which may provide external data to the chatbot 242 or the machine learning model 244. As an example, the external web server 260 may host a website, database, server, additional machine learning service, or the like, with additional data that is read or otherwise input to the machine learning model 244 when making predictions about natural language responses to output. To do this, the host application 220 may use bot configurations 238 that are exported from the source tenant 210 and installed in the target tenant 240. The bot configurations 238 may be bot specific.

During a live predictive operation within the target tenant 240, the chatbot 242 and/or the machine learning model 244 may retrieve data from the external web server 260 via the established communication channel 262 and use the retrieved data to make a prediction about a response to a chat inquiry from a user via a user interface (not shown). The chatbot 242 may include an avatar or other icon that visually depicts the chatbot in animated form. The chatbot 242 may output text-based responses via a chat application within the target tenant 240 in which the user is interacting with the chatbot 242.

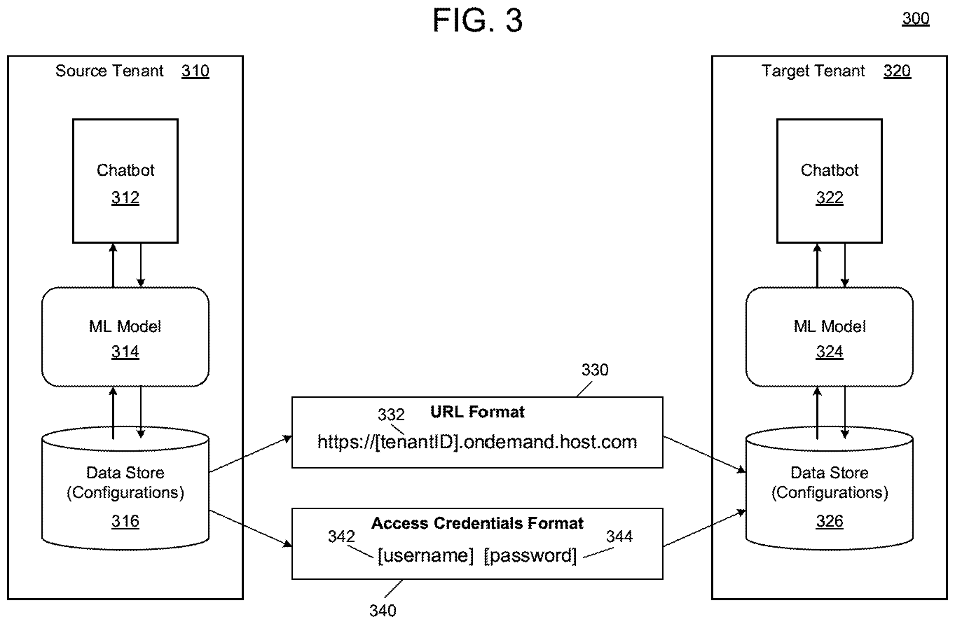

FIG. 3 illustrates a process 300 of transporting non-sensitive bot configurations across tenants in accordance with an example embodiment. Referring to FIG. 3, the host application may transport non-sensitive configurations (i.e., placeholders) which identify what data values the bot or the machine learning models are using without actually transporting the sensitive data (i.e., the login credentials of the users from the source tenant, the URL of the source tenant, etc.) such that this sensitive information is not transported into the new target tenant. In FIG. 3, the host system imports a chatbot 312 and a ML model 314 from a source tenant 310 and imports them as a chatbot 322 and a ML model 324 in a target tenant 320. Furthermore, configurations of the bot may be transported from a data store 316 of the source tenant 310 into a data store 326 of the target tenant 320.

In the example of FIG. 3, the host application transports two pieces of non-sensitive bot configurations from the source tenant 310 to the target tenant 320 including a URL format 330 of the bot including a tenant identifier 332 and an access credential format 340 including a username identifier 342 and a password identifier 344 which identify the type of credentials needed by the bot. For example, the identifier 342 refers to [username] which identifies the type of credential that is needed which in this case is a string value for user name, but not actual user values for such credentials that are generated and stored in the source tenant 310. That is, in this example, the tenant identifier 332, the username identifier 342, and the password identifier 344, are non-sensitive placeholders which do not identify the actual tenant ID, usernames, passwords, etc. of the source tenant 310 where the bot is exported from. The placeholders in this case may be generic values that identify a purpose or a type of the data value that is to be entered such as a string value with a character limitation of 32 characters, etc.

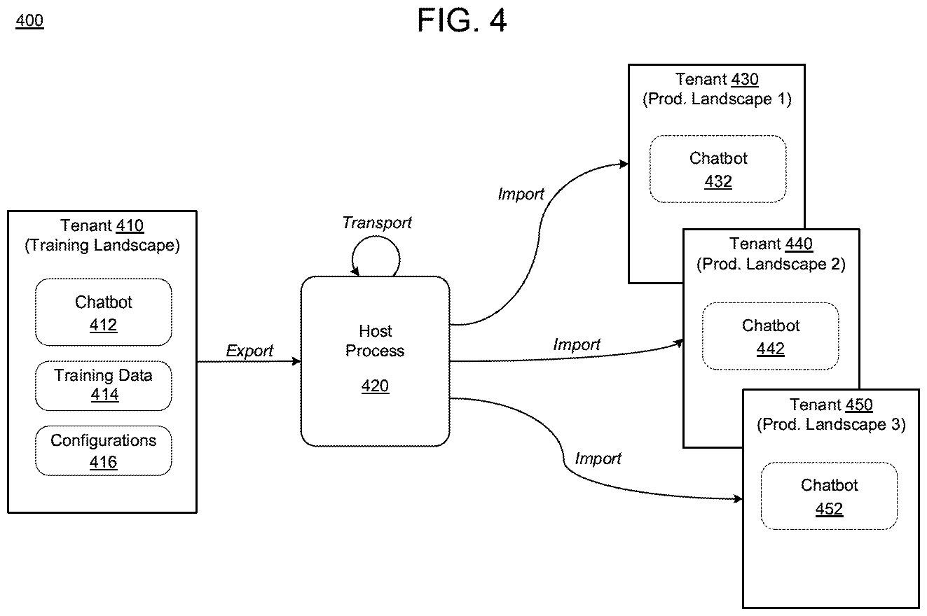

FIG. 4 illustrates a process 400 of importing a bot into multiple target tenants in accordance with an example embodiment. Referring to FIG. 4, a host application 420 may import a chatbot 412, training data 414, bot configurations 416, and the like, from a source tenant 410 such as a training environment. The host application 420 may simultaneously import the chatbot 412 into a plurality of tenants 430, 440, and 450, corresponding to a plurality of productive environments. Here, a new instance of the chatbot is installed as chatbot 432 in tenant 430, chatbot 442 in tenant 440, and chatbot 452 in tenant 450. Also, the training data 414 and the bot configurations 416 may be installed in the tenants 430, 440, and 450. This process may be performed simultaneously in response to a single request from a user via a user interface of the host application 420. As another example, the host application 420 may provide an application programming interface (API) which can be used to simultaneously spawn an instance of the chatbot in multiple tenants.

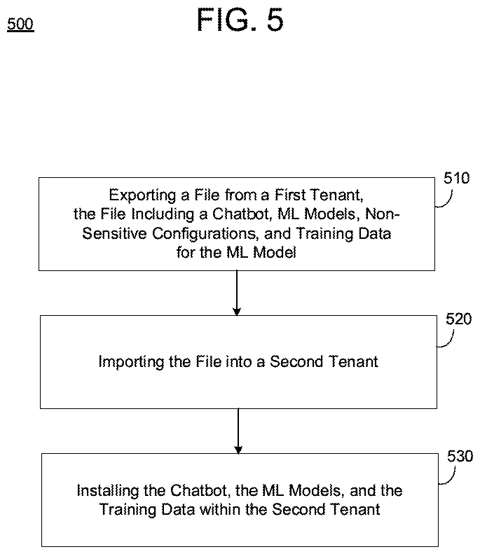

FIG. 5 illustrates a method 500 of transporting a bot across tenants in accordance with an example embodiment. As an example, the method 500 may be performed by a cloud platform, a web server, an on-premises server, a user device, a combination of devices, and the like. The method 500 may be an automated method that is performed by a software application such as a software application or suite of applications that host a bot development environment and a bot training environment.

Referring to FIG. 5, in 510, the method may include exporting a file from a first tenant in a multi-tenant environment. According to various embodiments, the file may be a zip file and it may include a chatbot program, one or more machine learning models for generating a response from the chat bot program, training data used to train the one or more machine learning models for generating the response, non-sensitive bot configurations, and the like. In 520, the method may include importing the file into a second tenant of the multi-tenant environment. In 530, the method may include installing the bot program, the one or more machine learning models, and the training data from the imported file within the second tenant of the multi-tenant environment.

In some embodiments, the exporting may include extracting a plurality of files from folders of a storage repository dedicated to the first tenant, compressing the plurality files into a zip file, and generating a hash of the zip file based on a hash key. In some embodiments, the importing may include retrieving the zip file from the first tenant, generating a verification hash of the zip file based on the hash key, and comparing the verification hash to the hash of the zip file prior to installing the bot program. In some embodiments, the exporting may further include storing access credentials for an external data source within the file, and the installing further comprises configuring a network connection between the bot program installed in the second tenant and the external data source based on the access credentials within the file.

In some embodiments, the exporting may further include storing, in the file, one or more custom configurations of the bot program within the first tenant, and the installing further comprises configuring the bot program installed within the second tenant based on the custom configurations of the bot program within the first tenant. In some embodiments, the method may further include displaying a user interface on a computing system associated with the second tenant, wherein the user interface includes controls for configuring settings of the bot program installed within the second tenant. In some embodiments, the importing may include simultaneously importing the file into a plurality of different tenants, and installing the bot program, the one or more machine learning models, and the training data within each tenant among the plurality of different tenants. In some embodiments, the method may further include executing the bot program in a runtime environment of the second tenant and generating a chat response to a user input based on the one or more machine learning models and the training data exported from the first tenant.

The above embodiments may be implemented in hardware, in a computer program executed by a processor, in firmware, or in a combination of the above. A computer program may be embodied on a computer readable medium, such as a storage medium or storage device. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

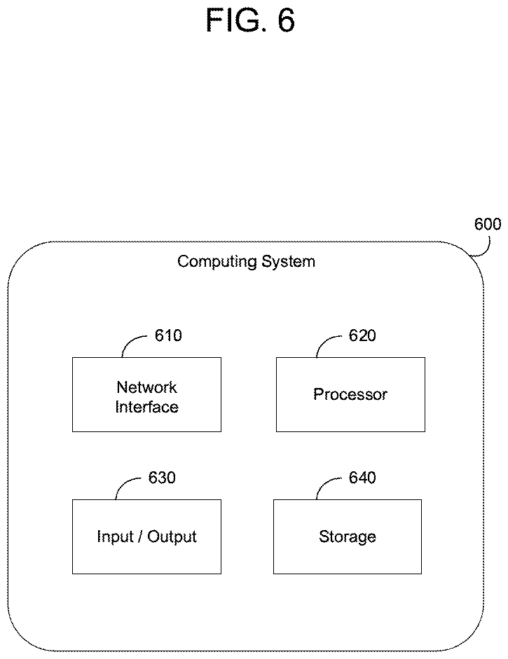

A storage medium may be coupled to the processor such that the processor may read information from, and write information to, the storage medium. In an alternative, the storage medium may be integral to the processor. The processor and the storage medium may reside in an application specific integrated circuit (“ASIC”). In an alternative, the processor and the storage medium may reside as discrete components. For example, FIG. 6 illustrates an example computing system 600 which may process or be integrated in any of the above-described examples, etc. As just one example, the computing system 600 may be the host platform 100 shown in FIG. 1. FIG. 6 is not intended to suggest any limitation as to the scope of use or functionality of embodiments described herein. The computing system 600 is capable of being implemented and/or performing any of the functionality set forth hereinabove.

The computing system 600 may include a computer system/server, which is operational with numerous other general purpose or special purpose computing system environments or configurations. Examples of well-known computing systems, environments, and/or configurations that may be suitable for use as computing system 600 include, but are not limited to, personal computer systems, server computer systems, thin clients, thick clients, hand-held or laptop devices, tablets, smart phones, databases, multiprocessor systems, microprocessor-based systems, set top boxes, programmable consumer electronics, network PCs, minicomputer systems, mainframe computer systems, distributed cloud computing environments, databases, and the like, which may include any of the above systems or devices, and the like. According to various embodiments described herein, the computing system 600 may be a tokenization platform, server, CPU, or the like.

The computing system 600 may be described in the general context of computer system-executable instructions, such as program modules, being executed by a computer system. Generally, program modules may include routines, programs, objects, components, logic, data structures, and so on that perform particular tasks or implement particular abstract data types. The computing system 600 may be practiced in distributed cloud computing environments where tasks are performed by remote processing devices that are linked through a communications network. In a distributed cloud computing environment, program modules may be located in both local and remote computer system storage media including memory storage devices.

Referring to FIG. 6, the computing system 600 is shown in the form of a general-purpose computing device. The components of computing system 600 may include, but are not limited to, a network interface 610, a processor 620 (or multiple processors/cores), an output 630 which may include a port, an interface, etc., or other hardware, for outputting a data signal to another device such as a display, a printer, etc., and a storage device 640 which may include a system memory, or the like. Although not shown, the computing system 600 may also include a system bus that couples various system components including system memory to the processor 620.

The storage device 640 may include a variety of computer system readable media. Such media may be any available media that is accessible by computer system/server, and it may include both volatile and non-volatile media, removable and non-removable media. System memory, in one embodiment, implements the flow diagrams of the other figures. The system memory can include computer system readable media in the form of volatile memory, such as random-access memory (RAM) and/or cache memory. As another example, the storage device 640 can read and write to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, the storage device 640 may include at least one program product having a set (e.g., at least one) of program modules that are configured to carry out the functions of various embodiments of the application.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Although not shown, the computing system 600 may also communicate with one or more external devices such as a keyboard, a pointing device, a display, etc.; one or more devices that enable a user to interact with computer system/server; and/or any devices (e.g., network card, modem, etc.) that enable computing system 600 to communicate with one or more other computing devices. Such communication can occur via I/O interfaces. Still yet, computing system 600 can communicate with one or more networks such as a local area network (LAN), a general wide area network (WAN), and/or a public network (e.g., the Internet) via network interface 610. As depicted, network interface 610 may also include a network adapter that communicates with the other components of computing system 600 via a bus. Although not shown, other hardware and/or software components could be used in conjunction with the computing system 600. Examples include, but are not limited to: microcode, device drivers, redundant processing units, external disk drive arrays, RAID systems, tape drives, and data archival storage systems, etc.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described regarding specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a memory; and
a processor configured to
export a file from a first tenant in a multi-tenant environment into the memory, wherein the file comprises a bot program, one or more machine learning models for generating a response from the bot program, and training data used to train the one or more machine learning models for generating the response,
import the file from the memory into a second tenant of the multi-tenant environment, and
install the bot program, the one or more machine learning models, and the training data from the imported file within the second tenant of the multi-tenant environment.

2. The computing system of claim 1, wherein the processor is further configured to export a plurality of files from folders of a storage repository dedicated to the first tenant, compress the plurality files into a zip file, and generate a hash of the zip file based on a hash key.

3. The computing system of claim 2, wherein the processor is configured to retrieve the zip file from the first tenant, generate a verification hash of the retrieved zip file based on the hash key, and compare the verification hash to the hash of the zip file prior to installing the bot program within the second tenant.

4. The computing system of claim 1, wherein the processor is configured to store access credentials for an external data source within the file, and the installing further comprises configuring a network connection between the bot program installed in the second tenant and the external data source based on the access credentials within the file.

5. The computing system of claim 1, wherein the processor is further configured to export one or more custom bot configurations of the bot program from the first tenant, import the one or more custom bot configurations into the second tenant, and configure the bot program installed within the second tenant based on the custom configurations of the bot program within the first tenant.

6. The computing system of claim 1, wherein the processor is further configured to display a user interface on a computing system associated with the second tenant, wherein the user interface includes controls for configuring settings of the bot program installed within the second tenant.

7. The computing system of claim 1, wherein the processor is configured to simultaneously import the file into a plurality of different tenants, and install the bot program, the one or more machine learning models, and the training data within each tenant among the plurality of different tenants.

8. The computing system of claim 1, wherein the processor is further configured to execute the bot program in a runtime environment of the second tenant and generate a chat response to a user input based on the one or more machine learning models and the training data exported from the first tenant.

9. A method comprising:
importing a file from a first tenant in a multi-tenant environment to a second tenant in the multi-tenant environment, wherein the file comprises a bot program, one or more machine learning models for generating a response from the bot program, and training data used to train the one or more machine learning models for generating the response;
unpacking the file within the second tenant of the multi-tenant environment; and
installing the bot program, the one or more machine learning models, and the training data from the unpacked file within the second tenant of the multi-tenant environment.

10. The method of claim 9, wherein the method further comprises exporting a plurality of files from folders of a storage repository dedicated to the first tenant, compressing the plurality files into a zip file, and generating a hash of the zip file based on a hash key.

11. The method of claim 10, wherein the importing further comprises retrieving the zip file from the first tenant, generating a verification hash of the zip file based on the hash key, and comparing the verification hash to the hash of the zip file prior to installing the bot program within the second tenant.

12. The method of claim 9, wherein the method further comprises storing access credentials for an external data source within the file, and the installing further comprises configuring a network connection between the bot program installed in the second tenant and the external data source based on the access credentials within the file.

13. The method of claim 9, wherein the method further comprises exporting one or more custom bot configurations of the bot program from the first tenant, importing the one or more custom bot configurations into the second tenant, and configuring the bot program installed within the second tenant based on the custom configurations of the bot program within the first tenant.

14. The method of claim 9, wherein the method further comprises providing an application programming interface (API) which includes controls for configuring settings of the bot program installed within the second tenant.

15. The method of claim 9, wherein the importing comprises simultaneously importing the file into a plurality of different tenants, and installing the bot program, the one or more machine learning models, and the training data within each tenant among the plurality of different tenants.

16. The method of claim 9, wherein the method further comprises executing the bot program in a runtime environment of the second tenant and generating a chat response to a user input based on the one or more machine learning models and the training data exported from the first tenant.

17. A non-transitory computer-readable storage medium comprising instructions which when executed by a processor cause a computer to perform a method comprising:
exporting a file from a first tenant in a multi-tenant environment, wherein the file comprises a bot program, one or more machine learning models for generating a response from the bot program, and training data used to train the one or more machine learning models for generating the response;
unpacking the file within a second tenant of the multi-tenant environment; and
installing the bot program, the one or more machine learning models, and the training data from the unpacked file within the second tenant of the multi-tenant environment.

18. The non-transitory computer-readable medium of claim 17, wherein the exporting comprises extracting a plurality of files from folders of a storage repository dedicated to the first tenant, compressing the plurality files into a zip file, and generating a hash of the zip file based on a hash key.

19. The non-transitory computer-readable medium of claim 18, wherein the method further comprises retrieving the zip file from the first tenant, generating a verification hash of the zip file based on the hash key, and comparing the verification hash to the hash of the zip file prior to installing the bot program.

20. The non-transitory computer-readable medium of claim 17, wherein the exporting further comprises storing access credentials for an external data source within the file, and the installing further comprises configuring a network connection between the bot program installed in the second tenant and the external data source based on the access credentials within the file.
